(19) United States
(12) Patent Application Publication
(10) Pub. No.: US 2018/0355839 A1
(43) Pub. Date: Dec. 13, 2018

(54) Portable Self-Contained Multi-Fluid Electrical Generator

(71) Applicant: Anthony F. Kroboth, Lehighton, PA (US)

(72) Inventor: Anthony F. Kroboth, Lehighton, PA (US)

(21) Appl. No.: 16/005,891

(22) Filed: Jun. 12, 2018

Related U.S. Application Data
(63) Continuation-in-part of application No. 62/518,054, filed on Jun. 12, 2017.

(51) Int. Cl. F03B 17/00; F03B 7/00

(52) U.S. Cl. CPC F03B 17/005; F03B 15/005; F03B 7/00

(57) ABSTRACT

Local electrical power generation using a self-sustaining, self-contained recirculating fluidic flow generating apparatus capable of operating a power wheel with any one of several different fluids is interconnected using a series of gears to an electrical power generating apparatus. The fluid is used to move and continue moving the power wheel in a single direction using a top fed overshoot and back flow method to produce rotation of the wheel. Movement of the wheel produces enhanced rotational force through the interconnection to and through the series of gears ultimately powering the electrical generating apparatus to produce electrical power sufficient to sustain the generating apparatus and power itself and a limited number of electrical devices.

### BACKGROUND OF THE INVENTION

The present invention deals with the generation of electrical power using a self-contained recirculating fluidic flow generating apparatus for generating electrical power. In one version of the invention, a sealed unit that is capable of operating a wheel with different fluids that is interconnected using a series of gears to an electrical power generating apparatus such as an alternator or generator. The fluids are used to move and continue moving the wheel in a single direction using a top fed overshoot and back flow method to produce rotation of the wheel. Rotational movement of the wheel produces enhanced rotational torque through the interconnection to and through the series of gears ultimately powering the electrical generating apparatus to produce electrical power at the output of the generator.

The wheel is powered by fluids being pumped from a reservoir to a distribution point above the wheel that permits the fluid to cascade onto the wheel creating a continuing single direction rotational motion of the wheel. One or more pumps for delivering the fluid from the reservoir to the distribution point above the wheel can be powered by electricity downloaded from an available power grid or electrical power distribution system, from a stored electrical power device such as a battery, from a propane or LP gas generator, or by the introduction of flowing water to the top of the wheel from an alternate source. Once the wheel is in continuing motion and has established a consistent number of revolutions per time unit, the generator will be producing a sufficient amount of electrical power to operate the pump(s) making the generator self-sustaining with excess electrical power available to be returned to the power grid.

It is, therefore, an object of the present invention that, once started, the generator becomes capable of sustaining itself with electrical power and creating additional power to be returned to the power grid. It is also an object of the present invention for the generator to be self-contained and sealed so that the full volume of fluid used for powering the generator remains available for use, for example, water will remain isolated within the generating apparatus and not be susceptible to evaporation. It is another object of the present invention to reduce the consumption of electrical power from external sources so that a residence or small commercial business can self-power electrical devices efficiently without the need for power to be obtained from the power grid.

Other objects will appear hereinafter.

### SUMMARY OF THE INVENTION

Generation of local electrical power using a self-sustaining, self-contained recirculating fluidic flow generating apparatus is produced using a sealed unit that is capable of operating a power wheel with any one of several different fluids. The power wheel is interconnected using a series of gears to an electrical power generating apparatus such as an alternator or generator. The fluids are used to move and continue moving the power wheel in a single direction using a top fed overshoot and back flow method to produce rotation of the wheel. Movement of the wheel produces enhanced rotational force through the interconnection to and through a series of gears ultimately powering the electrical generating apparatus to produce electrical power at the output of the generator.

The portable self-contained rotating fluid powered wheel electric power generator may be further described as comprising a sealed containment case for separating the internal space of the generator from the surrounding exterior environment to maintaining a static environment separate from evaporation and/or contamination of the motive force fluid contained within the sealed case. A fluid powered wheel is mounted for unidirectional rotation on an axle within the case above a fluid reservoir for retaining the motive force fluid used for rotational movement of the wheel. The wheel has a number of containment vessels in touching equally spaced array around its circumference for accumulating the motive force fluid for a limited period of time equal to a partial rotation of the wheel. One or more pumps are used for removing the motive force fluid from the reservoir and lifting the fluid upwards to a point substantially directly above the wheel to a distribution head for diffusing the fluid flow equally across the width of the wheel and allowing the pumped fluid to flow over the diffusing distribution head and into the several containment vessels arrayed around the circumference of the wheel. The falling fluid will cause initial and continuing rotational movement of the wheel with the introduction of the motive force fluid into the containment vessels. The fluid is retained in the several containment vessels until the wheel rotates approximately one-half of one complete revolution with the fluid beginning to drain back to the reservoir over a slightly downwardly inclined fluid diverter that permits an even flow of the fluid to drain back into the reservoir. The containment vessels arrayed about the circumference of the fluid powered wheel extend across the width of the wheel and extend outward from the surface of the wheel with in inwardly curving arcuate wall from the bottom apex of the containment vessel an approximate distance in excess of nine inches for retaining the motive force fluid for as long a period of time as possible commensurate with the speed of the power wheel.

A series of gears are interconnected between the wheel and a generator for producing electricity, the gears sized and interconnected for providing an ever increasing number of revolutions per minute such that the relatively slow rotation of the wheel is translated into a relatively high rate of revolutions at the last of the set of gears connected to the generator. The electric generator is capable of producing power at a level concomitant with the number of revolutions per minute of the last of said gears, the power level being sufficient to sustain power to the one or more pumps and to power a limited number of electrical devices connected to the electric power output of the generator. The set of gears are sized and connected between the fluid power wheel and the generator to achieve revolutions per minute in a range in excess of 3600 rpm.

The portable self-contained rotating fluid powered wheel electric power generator of further comprises a set of one or more electric storage batteries capable of providing electric power sufficient to start and maintain operation of the one or more pumps until the fluid powered wheel reaches its desired speed and the generator produces sufficient power at its output to sustain the operation of the pumps. One or more solar cell arrays are connected to the set of one or more electric storage batteries for recharging the batteries and retaining a full charge to be ready for use in starting the portable power generator. The portable electric power generator also comprises a switched power interconnection between the generator and a local power distribution panel for powering a number of desired electrical devices. The switched power interconnection is located between the one or more electric storage batteries and the local power distribution panel for switching the power source from the one or more electric storage batteries to the power output of the generator for powering the one or more pumps for circulating the motive force fluid to rotate the power wheel. The storage batteries can be engaged with the portable power generator through a manual start-up switching circuit that is part of the power sensor circuit in the internal power distribution panel of the power generator. In this way the one or more electric storage batteries are engaged to power the one or more pumps to imitate motive force fluid flow to the power wheel.

Although the preferred motive force fluid is water, water sometimes can freeze or become very viscous in extreme cold environments. Thus, an anti-freezing additive is combined in an appropriate amount to the motive force fluid, i.e., water, for continued fluidity in extreme cold conditions.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a block diagram of the electrical connections of the self-contained generating system of the present invention.

FIG. 2A is a front segmented view of the power wheel and gear system connection to the generator of the present invention.

FIG. 2B is a front segmented view of the power wheel and alternate gear system connection to the generator of the present invention.

FIG. 3 is a top plan view of the power wheel of the present invention showing the arrangement of related elements of the power generating system.

FIG. 4 is a right side plan view of the power wheel of the present invention showing the arrangement of related elements of the power generating system within an external case.

FIG. 5 is a front view of the power generating system of the present invention showing the arrangement of related elements of the power generating system located above the height of the reservoir.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

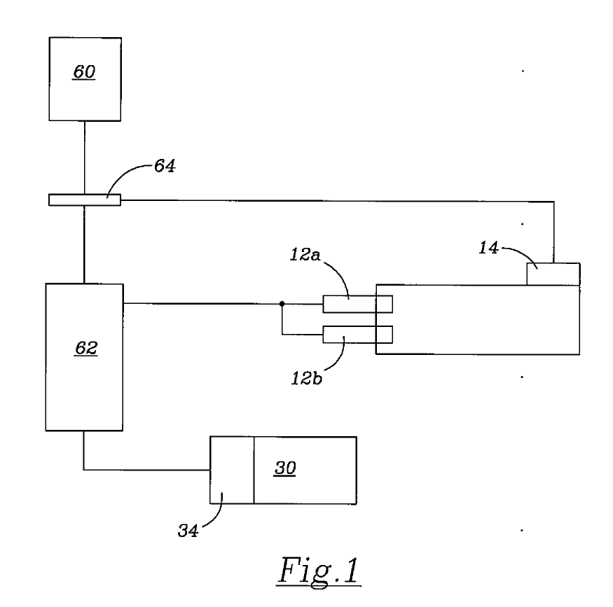

Referring now to the drawings in detail, where like numerals refer to like parts or elements, there is shown in FIG. 1 a block diagram showing the electrical interconnections of the generating system 10 of the present invention and an electrical power distribution system. The top box on the left of the diagram represents the existing power grid 60. The power grid 60 is connected to a power distribution center 62 such as a circuit breaker switching system. Interposed between the power grid 60 and the power distribution system 62 is an automatic power sensor and switch 64 that is capable of sensing the presence of power returning from the power generating system 10 to the power grid and permitting the local power generating system 10 to power all or a portion of the local power distribution system 62.

The power generating system 10 is a fluid powered wheel with the fluid circulated by a pair of pumps 12a, 12b. The fluid most readily obtainable is believed to be water since it is collectible as rain, or diverted from naturally occurring sources, or obtained from municipal sources. The water can be utilized without additives in most environmental conditions. However, in colder climates, especially in the colder months, such as late fall and winter into early spring, an additive to lower the freezing point of the water may be required to maintain operability of the power generating system 10 with a free flowing fluid of water and additive. The additive can be of a water antifreeze type, but can also be an environmentally friendly type containing a form of di-limonene that will reduce the freezing point of water substantially without damaging the environment if a leak occurs in the reservoir.

Each of the pumps receives its electrical power from the power distribution system 62 through one or more circuit breaker switches. The fluid powered wheel converts the fluid flow over the wheel into rotational motion translated through a series of gears to turn a generator 14 that produces electrical power and returns that power to the switch 64 for use in powering the local power distribution system 62 and returning power to the power grid 60. Alternatively, the one or more pumps may receive startup power from electrical storage batteries recharged from solar charging panels, or from a gas, propane or LP gas generator, or by the introduction of flowing water to the top of the wheel from an alternate water source.

The power wheel 20, powered in the present example by flowing water, is mounted on a freely rotating central shaft 21 and has attached to one side of the wheel a gear WW extending alongside the circumference of the power wheel 20. The power gear WW is interconnected through a series of gears to the generator 14 with each gear sized and spaced to provide sufficient torque and rotational force to cause the shaft of the generator to turn at sufficiently high revolutions per minute to produce electrical power.

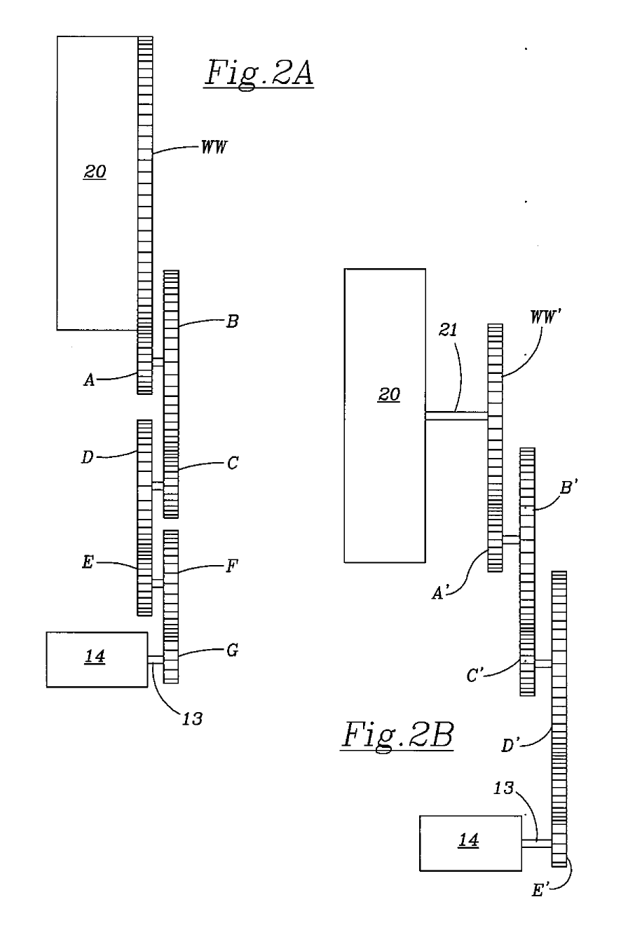

Referring now to FIG. 2A, a first of two alternate gear arrangements will be described. A power gear WW is sized with a diameter of approximately 72 inches and will turn concurrently with and at the same rate as the power wheel 20, which rate will be at approximately 12 revolutions per minute. The power gear WW may be mounted directly to the power wheel 20 or be attached to a central shaft (not shown in this view) passing through and arrayed along the central axis of the power wheel 20. The first gear, gear A, is sized at approximately 10 inches in diameter and meshes directly with the teeth of gear WW. Gear A is connected directly along a central axle to an array of internal teeth on gear B facing inward and arranged along the inside of the circumference of the gear. Gear B is approximately 30 inches in diameter. The rotational motion of gears A and B results in greater than 85 revolutions per minute. Gear B meshes directly with gear C, which gear is approximately 8 inches in diameter. Gear C is connected directly along a central axle to an array of internal teeth on gear D facing inward and arranged along the inside of the circumference of the gear. Gear D is approximately 20 inches in diameter. The rotational motion of gears C and D results in greater than 320 revolutions per minute. Gear D meshes directly with gear E that is approximately 8 inches in diameter. Gear E is connected directly along a central axle to an array of internal teeth on gear F facing inward and arranged along the inside of the circumference of the gear. Gear F is approximately 16 inches in diameter. The rotational motion of gears E and F results in greater than 800 revolutions per minute. Gear F meshes directly with gear G that is approximately 3.5 inches in diameter and is directly connected along a central axle that serves as the drive shaft 13 of generator 14. The rotational motion of gear G results in greater than 3600 revolutions per minute and, due to the direct connection described above, translates the same rotational speed to the drive shaft of generator 14.

Alternately, referring to FIG. 2B, a second set of gears can produce a similar result of in excess of 3600 revolutions per minute to the drive shaft of generator 14. Instead of being mounted directly to the power wheel 20, the first gear, gear WW′, is 7 inches in diameter and is mounted to the central shaft 21 of the power wheel 20 that will rotate at approximately 5 revolutions per minute. The first gear, gear A′, is sized at approximately 1.75 inches in diameter and meshes directly with the teeth of gear WW′. Gear A′ is connected directly along a central axle to an array of internal teeth on gear B′ facing inward and arranged along the inside of the circumference of the gear. Gear B′ is approximately 7 inches in diameter and meshes directly with gear C′, which gear is approximately 1.75 inches in diameter. Gear C′ is connected directly along a central axle to an array of internal teeth on gear D′ facing inward and arranged along the inside of the circumference of the gear. Gear D′ is approximately 7 inches in diameter and meshes directly with gear E′ that is approximately 1.625 inches in diameter. Gear E′ is connected directly along a central axle that serves as the drive shaft of generator 14. The rotational motion of gear E′ results in greater than 4800 revolutions per minute and, due to the direct connection described above, translates the same rotational speed to the drive shaft of generator 14. Thus, with fewer gears, sized differently from the first set described above, a greater number of revolutions per minute can be achieved. The number of gears, their respective size and arrangement, will be determined by the required or necessary number of revolutions per minute for the generator 14 to achieve the power output that is desired.

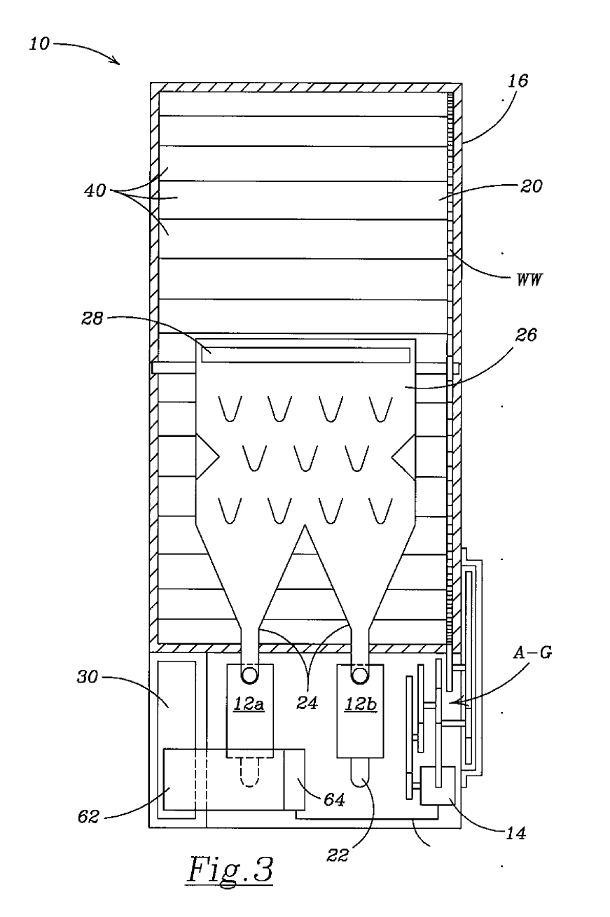

Referring now to FIGS. 3, 4 and 5, the top, side and front plan views of the present invention are shown. The container or case 16 that houses the power wheel 20 and a gear set, gears WW and A-G for example, and also houses a fluid retention, storage vessel or reservoir 18 for containing the water flow in a limited area to be redrawn for continued use as described below. The container 16 creates a sealed unit within which the fluid is not as readily susceptible to evaporation and/or contamination as it is continually reused. The storage vessel 18 is capable of containing in excess of approximately 150 gallons of fluid at any given time, but may contain up to 200 gallons of fluid. If additional fluid is required for start-up or normal operation of the power generator 10, the fluid is easily added to the storage vessel 18 by opening an access panel in the container 16 and adding the sufficient fluid to meet the operating requirements.

The fluid is drawn from the storage vessel 18 into one or more pump feed tubes 22 that are connected to the inlets of the pumps 12a, 12b. The fluid stored in the reservoir 18 is capable of providing the pumps with a sufficient flow to satisfy the requirement of 18000 gph to operate the power wheel 20 efficiently at a minimum rate of 5 revolutions per minute up to a top range of about 15 revolutions per minute. One pump that can achieve the requirement of 18000 gph is a water pump from the pond industry. An Evolution ESBB 18000 pump is a 2 hp water/garden pump operating at approximately 9 amps/2100 watts at 230 volts that will provide a flow rate of 18000 gallons per hour. This pump is provided as an example only and any pump that meets the above criteria will suffice. Other pumps that operate on either 240 volts ac or 24 volts dc obtained directly from storage batteries may also be used.

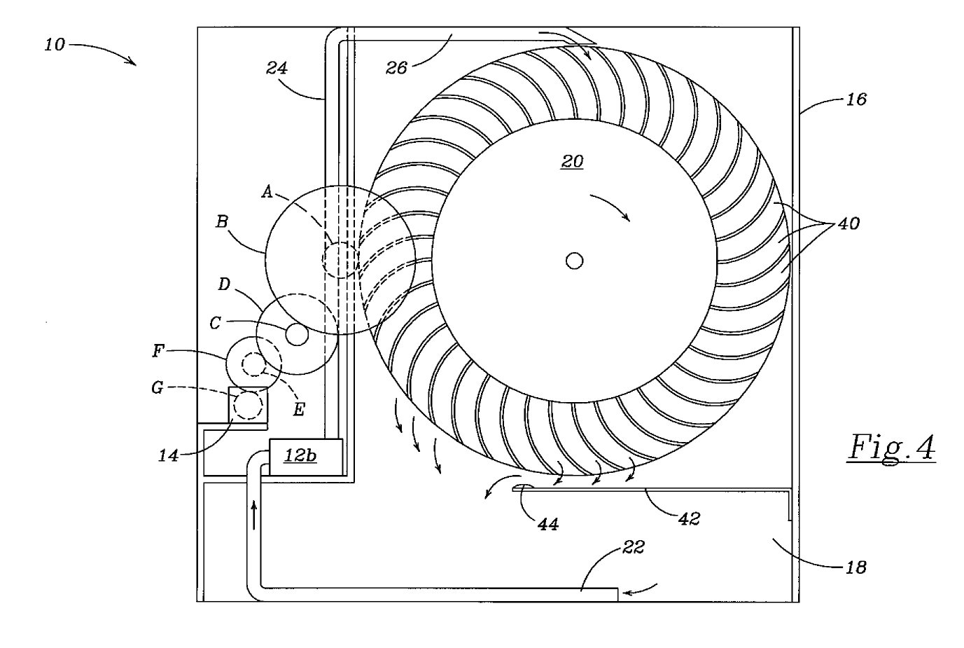

Upon leaving the pumps 12a, 12b the fluid flows through fluid distribution feed lines 24 to a fluid distribution head 26 that permits the fluid to expand from the limitations of the feed lines 24 to a substantially flat distribution head or diffuser 26. Diffuser 26 is approximately one inch in height and approximately 30 inches wide along the edge that overlies the power wheel 20 and is located approximately one inch above the power wheel 20 at its outlet. This configuration and placement of the diffuser 26 permits the fluid to expand laterally to approach the width of the power wheel 20 before allowing the fluid to cascade through elongated slot 28 at the end of the fluid distribution head or diffuser 26 and downward onto the power wheel 20 driving the rotation of the wheel. Alternatively, the fluid distribution head or diffuser 26 could be configured with an open end such that the fluid would cascade over the open end. See fluid flow arrows (FIG. 4) from storage vessel 18, through pumps 12a and 12b, through fluid distribution feed lines 24, over fluid distribution head 26, onto power wheel 20 and returning to storage vessel 18. As the power wheel 20 rotates, the fluid is carried by the wheel and eventually returned, by force of gravity, into the fluid storage vessel 18.

The power wheel 20 is configured with a series of compartments 40 equidistantly spaced in touching array about its outer circumference. Each of these pockets or compartments 40 extend across the entire width of the power wheel 20 a distance of approximately 30 inches. The compartments 40 are approximately 6 inches in depth and extend outward from a bottom apex and away from the surface of the power wheel a distance of approximately 9.5 inches at the top of the compartment. Each compartment 40 is curved away from the direction of rotational travel of the power wheel 20 in order to capture and retain the fluid for the greatest length of time before the fluid begins to drain out as a compartment reaches the lowest most point of the power wheel 20 rotation immediately above a flat planar fluid diverter 42 positioned above the reservoir 18 and extending under the power wheel 20 an approximate length equal to a point just beyond ½ the diameter of the power wheel 20 from the end wall of the case 16. The diverter 42 is positioned under and below the power wheel 20 a distance in the range of ¼ to one inch and extends across the entire width of the reservoir 18. A hump or raised lip 44 along the entire distal end of the diverter 42 is utilized for containing the fluid volume and pressure upstream of the lip 44 that creates a limited backflow or pressure of the fluid against the power wheel 20 in the space between the upper surface of the diverter 42 and the compartments 40 of the power wheel 20 that will assist in maintaining the rotational movement of the wheel 20 at the desired speed. The lip 44,in retarding the flow, also prevents fluid splash that could cause turbulence as the fluid reenters the reservoir 18. As the power wheel 20 continues to rotate, the compartments 40 become entirely empty of any remaining fluid as any such compartment 40 rotates through the lower left quadrant of the power wheel 20, as shown in FIG. 4, and returns toward the top of the wheel for reintroduction of the fluid into the compartments 40 to continue the rotation of the power wheel 20. This method of producing rotational motion of the power wheel 20 can be described as a top fed overshoot and back flow method to produce the rotation of the wheel. Initial movement of the power wheel 20 is caused by the filling of one or more compartments 40 that are located beneath the fluid flow from the diffuser 26 and the overflow spill to one or more compartments 40 that are positioned in a forward or clockwise location to the compartments 40 located directly beneath the diffuser 26. This causes the power wheel 20 to begin rotational movement in the direction of the filled compartments 40 in a clockwise rotation as shown in FIG. 4.

The generator 14 is powered by the rotation of the power wheel 20, with the centripetal force created thereby translated through the series of gears beginning with the WW gear from the power wheel 20 and ending with gear G (FIG. 2A) or gear E (FIG. 2B) directly powering the generator shaft of generator 14. The electrical output of generator 14 can be regulated by altering the number of revolutions per minute of the power wheel 20 which can vary between approximately 5 rpm to 15 rpm, but is preferably 12 rpm to create the required electrical power through the generator. One currently preferred generator is the model AR100 generator available from VOLTmaster America a division of Wanco, Inc. of Arvada, Colo. This generator can produce either 120 or 240 volts and can achieve a continuous output of approximately 9500 watts from a shaft rotational speed of 3600 revolutions per minute. Other power generators having greater shaft rotation speeds, or differently configured magnetic elements, can be used for achieving greater power outputs.

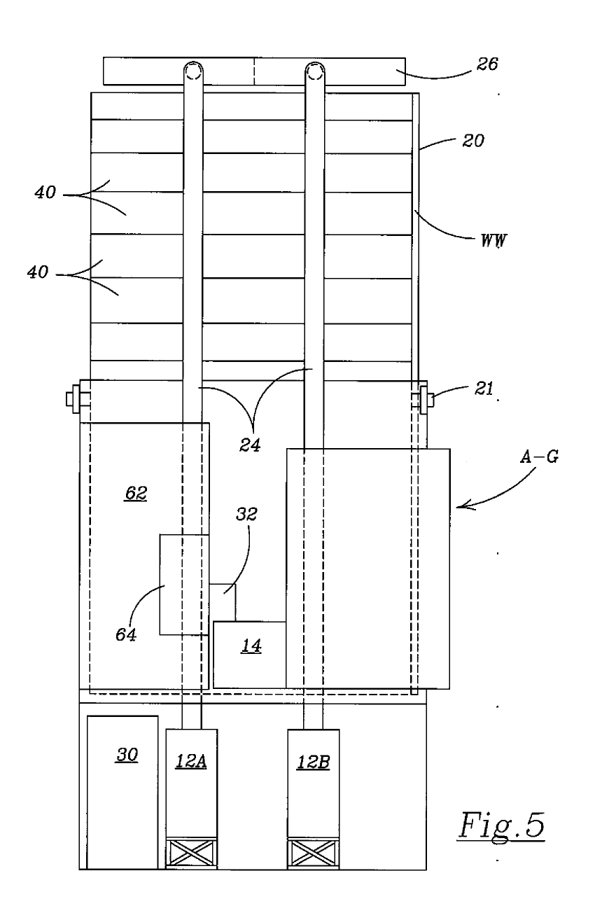

Power is transferred by wire 32 from the generator 14 to electrical connection and power distribution box 62. Power distribution box 62 can be located outside of and on a side of the case 16, or inside the case 16 as shown in FIGS. 3 and 5. In the arrangement shown in FIG. 5, the automatic power sensor and switch 64 is incorporated into the distribution box 62 so that local power distribution can be made to power local electrical devices when the power wheel 20 and generator 14 are producing sufficient power to do so. The range of power that can be generated depends upon the number of revolutions of the power wheel 20 and the gear array used to power the generator 14. If the number of revolutions of the generator approximates 3600 or greater, the power generated will be approximately 7200 watts. If the number of revolutions of the generator 14 approximates 4800 or greater, the power generated will be approximately 9600 watts. Either amount of generated power, 3600 or 4800 watts is believed sufficient to power a small cabin or to power all or a portion of a residence during a power outage. Excess generated power produced by the power wheel 20 and generator 14 can be applied to the power grid 60 as part of an overage of local power generation.

The case or container 16 for the power generator 10 encompasses the entirety of the power wheel 20, the gear set, the generator 14, the reservoir 18, the pumps 12a and 12b, the diffuser 26 and the diverter 42, as well as all related connections. Overall measurements for the portable power generator case 16 are approximately 8 ft. in height, 3 ft. in depth and 8 ft. in width. Access panels can be placed at desirable positions about the case 16 depending upon the precise arrangement of the elements contained therein for service and/or replacement. The case 16 provides a substantially sealed environment for the power generator 10 preserving the fluid from evaporation and/or contamination during both storage and normal operation.

The power generator 10 can also house its own storage batteries indicated as battery storage compartment 30. A number of batteries, preferably four 200 amp batteries can provide dc power for starting the pumps 12a, 12b by utilizing a dc-to-ac converter 34 producing the 240 volts ac required for starting and maintaining power to the pumps until the power wheel 20 comes up to desired speed and the generator 14 produces sufficient power for the pumps to operate from the power distribution box 62 and the circuit can be automatically switched over to operate internally from the power produced by the generator 10. An access panel in the case 16 can be opened and the battery circuit can be manually engaged at the sensor 64 to initiate power to the pumps 12a, 12b. The portable power generator 10 is also provided with one or more external interconnection points to the structure for which power is being supplied. These interconnection points emanate from power distribution box 62 and are preferably directly connected to a circuit distribution panel with circuit breakers for controlling power to individual circuits and electric power demands within the structure.

The portable power generator 10 of the present invention can be utilized to power a cabin or hunting lodge deep in the forest as one example of its intended uses. Another example is to utilize the portable power generator 10 as a source of power to a residence without power due to lack of electricity caused by natural causes or otherwise. Once set up adjacent to the structure with the electrical interconnections made, water can be stored in the reservoir within the sealed unit with the power generator remaining in storage mode until needed. When power is required, the storage batteries can be tapped to start the pumps and begin to circulate the water to create the rotational movement of the wheel to power the generator. Once up to speed, the generator is capable of generating 3.6 or 4.8 Kwh (depending upon configuration), enough power to heat or cool a small structure such as a cabin measuring 20×20 feet, light the cabin, power a small water heater, and provide power to a refrigeration unit for storing food. Roof mounted solar cells can be used to maintain the storage batteries with a sufficient charge level to power the pumps at startup of the portable power generator 10. Replenishment of water, or the addition of anti-freezing additives, can be added through access panels in the case and the case resealed preventing evaporation of the fluid from the reservoir. In the event that it is desired or required to move the power generator 10 the water can be drained, the electrical interconnections disconnected, and the unit mounted onto a trailer for relocation.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A portable self-contained rotating fluid powered wheel electric power generator comprising:
a sealed containment case for separating the internal space of the generator from the surrounding exterior environment for maintaining a static environment for the motive force fluid contained therein;
a fluid powered wheel mounted for unidirectional rotation on an axle within said case above a fluid reservoir for retaining the motive force fluid for rotational movement of the wheel, said wheel having a number of containment vessels in touching equally spaced array around its circumference for accumulating the motive force fluid for a limited period of time equal to a partial rotation of the wheel;
one or more pumps for removing said motive force fluid from the reservoir and lifting said fluid upwards to a point substantially directly above the wheel to a distribution head for diffusing the fluid flow equally across the width of the wheel and allowing the pumped fluid to flow over the diffusing distribution head and into the several containment vessels arrayed around the circumference of the wheel causing rotational movement of the wheel with the introduction of the motive force fluid into the containment vessels, said fluid being retained in the several containment vessels until the wheel rotates approximately one-half of one complete revolution with the fluid beginning to drain back to the reservoir over a slightly downwardly inclined fluid diverter that allows the fluid to drain evenly back into the reservoir;
a series of gears interconnected between the wheel and a generator for producing electricity, said gears providing an ever increasing number of revolutions per minute such that the relatively slow rotation of the wheel is translated into a relatively high rate of revolutions at the last of the set of gears connected to the generator;
said electric generator being capable of producing power at a level concomitant with the number of revolutions per minute of the last of said gears, said power level being sufficient to sustain power to the one or more pumps and to power a limited number of electrical devices connected to the electric power output of the generator.

2. The portable self-contained rotating fluid powered wheel electric power generator of claim 1 further comprising a set of one or more electric storage batteries capable of providing electric power sufficient to start and maintain operation of the one or more pumps until the fluid powered wheel reaches desired speed and the generator produces sufficient power at its output to sustain the operation of the pumps.

3. The portable self-contained rotating fluid powered wheel electric power generator of claim 1 wherein said containment vessels arrayed about the circumference of the fluid powered wheel extend across the width of the wheel and extend outward from the surface of the wheel with in inwardly curving arcuate wall from the bottom apex of the containment vessel an approximate distance in excess of nine inches for retaining said motive force fluid for as long a period of time as possible commensurate with the speed of the power wheel.

4. The portable self-contained rotating fluid powered wheel electric power generator of claim 1 wherein said set of gears are sized and connected between the fluid power wheel and the generator to achieve revolutions per minute in a range in excess of 3600 rpm.

5. The portable self-contained rotating fluid powered wheel electric power generator of claim 1 further comprising a switched power interconnection between said generator and a local power distribution panel for powering a number of desired electrical devices.

6. The portable self-contained rotating fluid powered wheel electric power generator of claim 2 further comprising a switched power interconnection between the one or more electric storage batteries and the local power distribution panel for switching power source from the one or more electric storage batteries to the power output of the generator for powering the one or more pumps for circulating the motive force fluid to rotate the power wheel.

7. The portable self-contained rotating fluid powered wheel electric power generator of claim 1 wherein said motive force fluid consists of water.

8. The portable self-contained rotating fluid powered wheel electric power generator of claim 1 wherein said motive force fluid consists of water and an anti-freezing additive for continued fluidity in extreme cold conditions.

9. The portable self-contained rotating fluid powered wheel electric power generator of claim 2 further comprising one or more solar cell arrays for recharging the set of one or more electric storage batteries.

10. The portable self-contained rotating fluid powered wheel electric power generator of claim 1 further comprising a manual start-up switching circuit as part of the power sensor circuit in the internal power distribution panel of the power generator for engaging said one or more electric storage batteries to power the one or more pumps to imitate motive force fluid flow to the power wheel.
